(19) United States
(12) Patent Application Publication
(10) Pub. No.: US 2016/0042833 A1
(43) Pub. Date: Feb. 11, 2016

(54) ELEMENT WIRE ASSEMBLY AND METHOD FOR MANUFACTURING THE SAME

(71) Applicants: Yoshitomo KAWANISHI, Toyota-shi, Aichi-ken (JP); Daichi MARUYAMA, Toyota-shi, Aichi-ken (JP); Shuxin DONG, Nagakute-shi, Aichi-ken (JP); Hisaaki TAKAO, Nagakute-shi, Aichi-ken (JP); Shinya URATA, Nagak-ute-shi, Aichi-ken (JP); Atsuto OKAMOTO, Nagakute-shi, Aichi-ken (JP); Hideo NAKAI, Nagakute-shi, Aichi-ken (JP); TOYOTA JIDOSHA KABUSHIKI, Aichi-ken (JP)

(72) Inventors: Yoshitomo KAWANISHI, Nagoya-shi, Aichi-ken (JP); Daichi MARUYAMA, Nagoya-shi, Aichi-ken (JP); Shuxin DONG, Owariasahi-shi, Aichi-ken (JP); Hisaaki TAKAO, Seto-shi, Aichi-ken (JP); Shinya URATA, Nagakute-shi, Aichi-ken (JP); Atsuto OKAMOTO, Miyoshi-shi, Aichi-ken (JP); Hideo NAKAI, Nisshin-shi, Aichi-ken (JP)

(73) Assignee: TOYOTA JIDOSHA KABUSHIKI KAISHA, Toyota-shi, Aichi-ken (JP)

(21) Appl. No.: 14/782,927

(22) PCT Filed: Apr. 8, 2014
(86) PCT No.: PCT/IB2014/000499

§ 371 Date: Oct. 7, 2015

(30) Foreign Application Priority Data
Apr. 11, 2013 (JP) 2013-083054

(51) Int. Cl. H01B 5/12; H01B 13/00

(52) U.S. Cl. CPC H01B 5/12; H01B 13/0016

(57) ABSTRACT

A method for manufacturing an element wire assembly includes: a first step of bunching up and rolling or drawing a plurality of circular cross-section conducting wires (1) to shape each of the conducting wires into a polygon in cross section and form the conducting wires (1′) and form a conducting wire assembly (10); and a second step of heat-treating the conducting wire assembly (10) to form an oxide film (2) on the periphery of each of the conducting wires (1′) to form element wires (3) and, form an element wire assembly (20).

### BACKGROUND OF THE INVENTION

1. Field of the Invention

The present invention relates to an element wire assembly that is applicable to, for example, motor coils as windings in which a plurality of element wires are bunched up into one unit and a method for manufacturing the element wire assembly.

2. Description of Related Art

Technological development is conducted on a daily basis for attaining a downsizing and high output of a number of in-vehicle motors including a motor for driving a hybrid vehicle or an electric vehicle. One way to attain both objectives includes enhancing the space factor of a coil in a slot of a stator core. In addition, one way to enhance the space factor of the coil includes applying a rectangular cross-section wire to an element wire for the coil in place of a circular cross-section element wire (round wire) that has been commonly used so far.

The rectangular wire that is conventionally used in general includes the element wire in which an insulating film made of thermoplastic resin such as polyamide (PA) or polyphenylene sulfide (PPS) or thermosetting resin such as enamel resin is formed on the periphery of a rectangular copper conducting wire and the cross section is shaped into a rectangle.

Although the space factor of the coil can be enhanced by using the rectangular copper wire as the element wire as described above, the increase in the cross-sectional area of the copper element wire causes a problem of the increase in eddy current loss.

One way to reduce such eddy current loss includes using an element wire assembly (also referred to as assembled copper wires) in which fine wires having small cross sections are bunched up. However, when the element wire assembly is formed by bunching up the element wires provided with an enamel coat or the like on the periphery of the copper conducting wire and then the coil is formed by winding the element wire assembly, clearance is easily created between the adjacent element wires. Thus, this may cause a problem of decrease in the space factor of the coil by contraries.

Meanwhile, there is a way to prevent the decrease in the space factor described above by bunching up the element wires of different shapes to form the element wire assembly; however, such an element wire assembly requires the preparation of the element wires of different shapes, and this may need a manufacturing time and cause the increase in manufacturing cost.

Japanese Patent Application Publication No. 2000-090747 (JP 2000-090747 A) discloses a rectangular Litz wire. The rectangular Litz wire is formed in a rectangle in cross section by rolling a round Litz wire that is circular in cross section and in which a plurality of enameled element wires are twisted together. Adhesive tape on which an adhesive material or a thermoplastic material is applied is longitudinally applied to the outer periphery of the rectangular Litz wire.

Japanese Patent Application Publication No. 2009-199749 (JP 2009-199749 A) discloses a method for manufacturing a conducting wire including twisting a plurality of element wires coated with an insulating layer to constitute a stranded wire, compression-molding the stranded wire with a shaping die in this state to shape the cross section of the stranded wire into a specified shape, and then coating the surface of the stranded wire with the insulating layer that is thicker than the thickness of the insulating layer constituting the surface of the element wire.

Furthermore, Japanese Patent Application Publication No. 2006-100077 (JP 2006-100077 A) discloses a wire rod for a winding that has a conductor insulating film on the outside of a conductor. One conductor of a specific cross section is formed by assembling a plurality of split element wires, and each of the split element wires is constituted by a conductor core wire and a core wire insulating film that covers the conductor core wire. The method for manufacturing a wire rod for a winding disclosed in JP 2006-100077 A includes a step of preparing a plurality of conductor core wires, a step of forming the split element wires by forming the core wire insulating film on each of the conductor core wires, a step of forming the conductor with a specified cross-sectional shape by assembling the plurality of split element wires, and a step of forming the conductor insulating film on the outside of the conductor.

As described above, JP 2000-090747 A, JP 2009-199749 A, and JP 2006-100077 A disclose the element wire assembly and the method for manufacturing the same; however, each disclosure has been based on the manufacturing method in which the element wires having the insulating film are bunched up and formed in one unit by rolling and other processes. Thus, those disclosures do not solve the aforementioned problem, that is, the problem in which a clearance is easily created between adjacent element wires and the space factor of the coil decreases when the coil is formed by using the element wires.

### SUMMARY OF THE INVENTION

The present invention relates to an element wire assembly in which a plurality of element wires are bunched up into one unit and a method for manufacturing the element wire assembly, and also the present invention provides the method for manufacturing the element wire assembly in which a coil with a high space factor and a superior eddy current loss reduction performance can be fabricated and the element wire assembly that is fabricated by the method for manufacturing the same.

A first aspect of the present invention relates to a method for manufacturing an element wire assembly including: a first step of bunching up and rolling or drawing a plurality of circular cross-section conducting wires to shape each of the conducting wires into a polygon in cross section and form a conducting wire assembly; and a second step of heat-treating the conducting wire assembly to form an oxide film on a periphery of each conducting wire and form the element wire assembly that includes a plurality of element wires each of which consists of the conducting wires and the oxide film.

In other words, circular cross-section conducting wires are bunched up and rolled or drawn, a polygonal cross-section conducting wire assembly is first formed, and then the conducting wire assembly is heat-treated, an oxide film is formed on the periphery of each of the conducting wires that constitute the assembly, and an element wire assembly that includes the conducting wires and oxide films is formed.

By bunching up and rolling or drawing the circular cross-section conducting wires to shape the conducting wires into a polygon in cross section and eliminate the clearance between the adjacent conducting wires, and then forming the oxide film on the periphery of the conducting wire, the manufactured element wire assembly has no void or very little voids in its inside, and when the element wire assembly is wound around a tooth to form a coil, the coil with a high space factor can be formed.

The circular cross-section conducting wire used in the first step may be a conducting wire made of copper, for example. Here, the “circular” means the shape of not only a perfect circle but also circles including a polygon approximate to a circle, an ellipse, and a flattened circle.

In addition, the “polygon” that is formed by the deformation of the circular cross-section conducting wire by rolling or drawing in the first step means a rectangle such as a square or an oblong as well as multiangular shapes other than the rectangle. In the method for manufacturing according to the present invention, the shape of the element wire assembly itself that is formed finally is a rectangle.

The cross sectional shapes of all conducting wires are processed to make close contact with each other by rolling or drawing, and therefore the conducting wire assembly without any clearance between the conducting wires can be formed.

In the second step, the conducting wire assembly is heat treated, and therefore the surfaces of all conducting wires constituting the assembly are oxidized, and for example, copper oxide that is the oxide film is formed on the periphery of the conducting wire made of copper. The formed copper oxide has enough electric resistance, and therefore the eddy current loss reduction effect can be expected.

The conducting wire without insulating film on its periphery may be used for the circular cross-section conducting wire before the rolling.

In addition, a second aspect of the present invention relates to the element wire assembly manufactured by the method for manufacturing the same as described above.

Furthermore, in this element wire assembly, the thickness of the oxide film may be 5 nm to 500 nm.

The thickness of the oxide film that is thicker than 500 nm is not preferable because the oxide film itself becomes brittle and is easily broken in processing or when left standing in a market for long period. On the other hand, the thickness of the oxide film thinner than 5 nm is not preferable due to insufficient electric resistance, and therefore the value range of 5 nm to 500 nm has been determined.

In consideration of adhesion durability at high temperatures now, it is further preferable that the thickness of the oxide film be 200 nm or less (Hereinafter, the adhesion durability at high temperatures will be referred to an a high temperature adhesiveness durability). In order to prevent the influence of surface roughness of the conducting wire after rolling or drawing, the thickness of the oxide film is desirably 50 nm or greater. The high temperature adhesiveness durability is measured by heating a copper base-material with the oxide film at a temperature of 200° C. for a specified time, conducting a tape peel experiment with cross-cut at intervals of 1 mm on the oxide film, and determining the presence and absence of peeling-off of the oxide film. If no peeling-off of the oxide film is observed, the high temperature adhesiveness durability is evaluated to be passed.

It can be understood from the above descriptions that, according to the method for manufacturing the element wire assembly and the element wire assembly manufactured by the method for manufacturing the same of the present invention, the circular cross-section conducting wires are bunched up and rolled or drawn, the polygonal cross-section conducting wire assembly is first formed, and then the conducting wire assembly is heat-treated. By heat treatment, the oxide film is formed on the periphery of each of the conducting wires that constitute the assembly, and the element wire assembly that includes the conducting wires and oxide films is formed. In this way, the coil with a high space factor and a superior eddy current loss reduction effect can be formed.

### BRIEF DESCRIPTION OF THE DRAWINGS

Features, advantages, and technical and industrial significance of exemplary embodiments of the invention will be described below with reference to the accompanying drawings, in which like numerals denote like element, and wherein:

FIGS. 1A to 1C are flow diagrams that illustrate, in this order, the method for manufacturing the element wire assembly according to the embodiments of the present invention.

### DETAILED DESCRIPTION OF EMBODIMENTS

A description will hereinafter be made on embodiments of the method for manufacturing the element wire assembly according to the present invention with reference to the drawings. The illustrated example shows one form of the wire assembly in which six conducting wires of circular cross section are bunched up in three columns and two rows and rolled together, and then heat-treated. However, it should be noted that there are various numbers and forms of conducting wires to be bunched up (in two columns and three rows, or five columns and three rows, for example) besides the illustrated example.

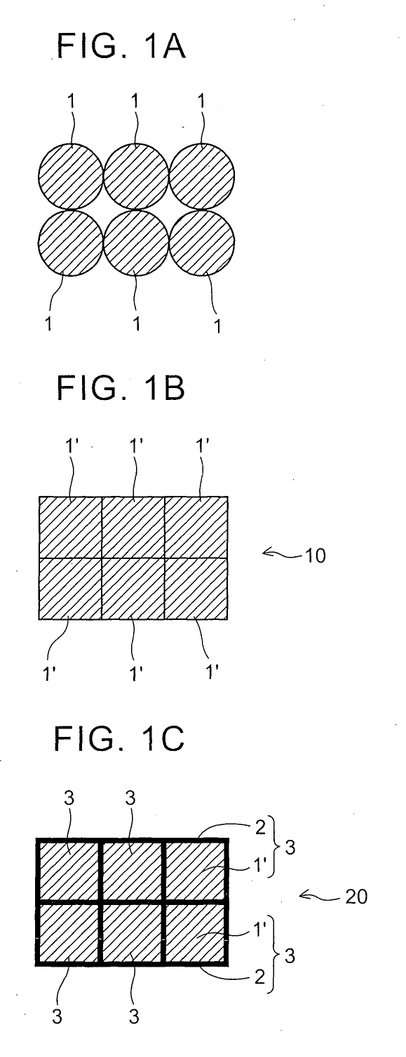

(Embodiments of Element Wire Assembly and Method for Manufacturing the Element Wire Assembly) FIGS. 1A to 1C are flow diagrams that illustrate, in this order, the method for manufacturing the element wire assembly according to the embodiments of the present invention.

First, as shown in FIG. 1A, conducting wires 1 that have equal dimensions and are circular in cross section and made of copper are bunched up in three columns and two rows. As a form of “bunch(ing) up” herein, there are the form of simply placing and stacking the conducting wires side by side, the form of placing and stacking the conducting wires side by side and then twisting together, or the form of placing and stacking the conducting wires side by side and then braided together. Preferably, the conducting wires 1 to be used have no insulating films on the periphery.

Next, six circular cross-section conducting wires 1 that are bunched up in three columns and two rows are rolled or drawn, and thus six rectangular cross-section conducting wires 1′ are formed as shown in FIG. 1B, which forms a conducting wire assembly 10 (first step). It should be noted that each conducting wire 1′ to be processed may have a polygonal shape besides the rectangular shape.

The conducting wire assembly 10′ shown in FIG. 1B has a structure in which the conducting wires 1′ of rectangular cross section are arranged in close contact with each other, and therefore the conducting wire assembly 10 has no clearance or very little clearances between the adjacent conducting wires 1′.

After the conducting wire assembly 10 is formed in the first step, as shown in FIG. 1C, the entire conducting wire assembly 10 is heat-treated, and the periphery of each conducting wire 1′ is oxidized to form an oxide film 2. Then, an element wire assembly 20 is formed with a set of element wires 3 that include rectangular cross-section conducting wires 1′ and oxide films 2 on the periphery (second step). The entire surface of the conducting wire 1′ is covered by the oxide films 2.

According to the method for manufacturing the element wire as shown in FIGS. 1A to 1C, the circular cross-section conducting wires 1 are bunched up to be rolled or drawn, and the conducting wire assembly 10 is formed with a set of rectangular cross-section conducting wires 1′ in the first instance. Then, the conducting wire assembly 10 is heat-treated, the oxide films 2 are formed on the periphery of all the conducting wires 1′ constituting the assembly 10, and thus the rectangular element wire assembly 20 is formed with a set of element wires 3 that are provided with the conducting wires 1′ and the oxide films 2. In this way, the assembly for a coil with a high space factor and a superior eddy current loss reduction effect can be fabricated.

[Experiment and the results in which eddy current loss reduction effect could be determined] The inventors of the present invention fabricated the test pieces of element wire assembly according to Examples 1 and 2 and Comparative Examples 1 to 4 as shown in Table 1 below and measured the eddy current loss by using an AC magnetic property test equipment.

(Fabrication Method of Element Wire Assembly of Examples 1 and 2) The used conducting wires (fine wires) of circular cross section were prepared by bunching up and twisting six round solid copper wires (1.1 mm dia.) together. Then, a rectangular conducting wire assembly of 2.0×3.4 mm was formed by using a die and placed in a drying oven. After that, the periphery of the conducting wire was oxidized under a specified condition to form the oxide film, and therefore the element wire assembly was prepared by bunching up and twisting six element wires together that were constituted by the rectangular conducting wires and the oxide films.

(Measuring Method of Eddy Current Loss) The AC magnetic property test equipment (manufactured by METRON, Inc., popularly called a C-Epstein measurement device) was used to measure the alternating-current loss of the element wire assembly. At this time, the magnetic flux having the frequency. of 0 to 2 kHz and the magnetic flux density of ±0.1 T was generated in the test equipment. The loss reduction ratio for any of the test pieces was calculated with respect to the loss in a rectangular bare copper conducting wire of 2.0×3.4 mm. In Example 1, the eddy current loss of the bare conducting wire was 100 W, but it was reduced to 15 W by the oxide film. That is to say, the loss reduction ratio in Example 1 was 85%.

(Details of Test Pieces) <Comparative Example 1> The conducting wires were not oxidized, and the element wire assembly was formed without the oxide films.

<Comparative Example 2> The conducting wires were kept circular in cross section without being rolled and then heat-treated (oxidized) at 250° C. for 10 min. After that, the conducting wires were twisted together and rolled so that each conducting wire had a rectangular shape.

<Comparative Example 3> The circular cross-section conducting wires were twisted together and then heat-treated (oxidized) at 250° C. for 10 min. After that, the conducting wires were rolled so that each conducting wire had a rectangular shape.

<Examples 1 and 2> The element wire assembly was fabricated in accordance with the fabrication method of Examples 1 and 2 described above.

<Comparative Example 4> Six enameled wires (circular cross-section element wires having polyamide-imide films of 1.1 mm dia.) were twisted together and worked with the die so that all the element wires had equal dimensions and the rectangular shape.

TABLE 1

| | Comparative | Comparative | Comparative | | | Comparative |
|---|---|---|---|---|---|---|
| | Example 1 | Example 2 | Example 3 | Example 1 | Example 2 | Example 4 |
| Oxidation | No | Circular | Oxide film | Rolling | Rolling | Element |
| Process | oxidation | cross-section | formation | followed | followed | wire |
| Order | | conducting | followed | by oxide | by oxide | having |
| | | wire (no | by rolling | film | film | enamel |
| | | oxide film) | process | formation | formation | coat |
| Oxidizing | — | 250° C. | 250° C. | 250° C. | 275° C. | — |
| Condition | | 10 min. | 10 min. | 10 min. | 10 min. | |
| Thickness of | — | 50 nm | 50 nm | 50 nm | 200 nm | — |
| Oxide Film | | | | | | |
| Electrical | — | — | — | 0.3 Ω | 3 Ω | — |
| Resistance | | | | | | |
| Loss Reduction | 60% | 60% | 55% | 85% | 85% | 85% |
| Ratio (**) | | | | | | |
| Oxide Film Effect | — | No | No | Yes | Yes | — |
| Space Factor | 70% | 70% | 70% | 70% | 70% | 55% |

(**) representing eddy current loss reduction effect with respect to the rectangular wire having the same dimensions.

(Consideration) In Examples 1 and 2, the formation of the oxide film by heat treatment is carried out after rolling, and thus the oxide film can uniformly be formed on all the conducting wires. On this account, it is supposed that the loss reduction effect of Examples 1 and 2 is higher than that of Comparative Examples.

In Comparative Examples 2 and 3, the oxide film is formed on the periphery of the conducting wire before rolling and other processes, and thus a part of the oxide film is damaged during twisting or rolling. On this account, it is supposed that the loss reduction effect of Comparative Examples 2 and 3 is lower than that of Examples.

In Comparative Example 4, insulation is fully provided by the enamel coat between the adjacent element wires, and therefore the loss reduction effect of Comparative Example 4 is as high as that of Examples 1 and 2. However, in Comparative Example 4, the space factor is lower than that of Examples 1 and 2.

It was verified by the aforementioned experimental results that the element wire assembly manufactured by the manufacturing method according to the examples of the present invention had a high space factor and superior eddy current loss reduction performance.

While the embodiments of the present invention have been described with reference to the drawings, it is to be understood that the specific constitution is not limited to the described embodiments. When design change or other modification is made without departing from the scope of the invention, such a change is intended to fall within the present invention. For example, the element wire according to the aforementioned examples can be wound on a stator core of the motor, and thus the motor with a high space factor can be produced.

1. A method for manufacturing an element wire assembly comprising:
a first step of bunching up and rolling or drawing a plurality of circular cross-section conducting wires to shape each of the conducting wires into a polygon in cross section and form a conducting wire assembly; and
a second step of heat-treating the conducting wire assembly to form an oxide film on a periphery of each conducting wire and to form the element wire assembly that includes a plurality of element wires each of which consists of the conducting wire and the oxide film.

2. The method according to claim 1, wherein a thickness of the oxide film is 5 nm to 500 nm.

3. The method according to claim 2, wherein the thickness of the oxide film is 50 nm to 200 nm.

4. An element wire assembly manufactured by the method according to claim 1.

5. The element wire assembly according to claim 4, wherein a thickness of the oxide film is 5 nm to 500 nm.

6. The element wire assembly according to claim 5, wherein the thickness of the oxide film is 50 nm to 200 nm.
